(19) United States
(12) Patent Application Publication
(10) Pub. No.: US 2007/0063893 A1
(43) Pub. Date: Mar. 22, 2007

(54) Spot Locator

(75) Inventors: Robert Ray Horton, Pueblo West, CO (US); Phillip Wayne Coiner, Pueblo, CO (US)

Correspondence Address: BANNER & WITCOFF, 1001 G STREET N W, SUITE 1100, WASHINGTON, DC, 20001, US

(73) Assignee: GPS SOURCE, INC., Pueblo, CO (US)

(21) Appl. No.: 11/275,669

(22) Filed: Jan. 23, 2006

Related U.S. Application Data
(60) Provisional application No. 60/714,860, filed on Sep. 8, 2005.

(51) Int. Cl. G01S 5/14

(52) U.S. Cl. 342/357.09

(57) ABSTRACT

A system and method is provided for enhancing the coverage and capabilities of Global Navigation Satellite Systems (GNSS) using signal emitters. The signal emitters generate and emit GNSS Radio Frequency (RF) signals that may possess varying sets of information. In some situations, the information may include relative pseudo-random code phases and Doppler frequencies that correspond to the known location of the signal emitter or other locations. In some situations, the GNSS satellite constellation time, and the GNSS satellites that may be visible at a known location were the authentic GNSS signals not obscured or at another location.

### RELATED APPLICATION INFORMATION

This application claims priority to U.S. Ser. No. 60/714,860, filed Sep. 8, 2005, whose contents are expressly incorporated herein by reference.

### FIELD OF THE INVENTION

Aspects of the present invention generally relate to global navigation satellite systems. More specifically, the present invention relates to enhancing the coverage area of satellite systems.

### BACKGROUND OF THE INVENTION

Global Navigation Satellite System (GNSS) is a term used generally to describe radio navigation satellite systems that orbit the earth and emit reference signals that enable certain types of radio navigation receivers to determine their location on or near the surface of the earth. For example, the Global Positioning System (GPS) is a GNSS currently in use by the United States. In addition to the GPS system, there are other similar GNSS systems that currently perform or, in the future, will perform similar functions. These systems include the European Union's Galileo system, the Russian Federation's GLONASS system, and the Japanese Quasi-Zenith Satellite System (QZSS).

GNSSs emit radio frequency (RF) signals that, when received and processed, can provide location and navigation services to individual persons for recreational uses, to commercial entities for use in “for profit” activities, to government and military entities for navigation of weapon systems and to public safety organizations to assist in directing emergency personnel. In one example, many modern vehicle manufacturers incorporate GPS navigation systems in commercial vehicles to guide drivers in unfamiliar areas. Similarly, GPS type devices have also been adapted to cell phone technology so that rescue personnel are able to locate a missing or lost individual in emergency situations.

GNSS satellite systems typically operate at mid-earth orbits (approximately 10,900 nautical miles high) and at Geo-synchronous orbits (approximately 19,300 nautical miles high). Due to the altitude of these satellite systems, the signals are very weak when they reach the surface of the earth. In order to enable the design of small antennas with high gain, frequencies for GNSS satellite transmission are typically chosen in the L bands (approximately 1 GHz to 2 GHz). The disadvantage of this frequency choice is that systems operating at this frequency generally operate by line of sight. That is, L band frequencies exhibit poor signal penetration into dense building materials or earth. Thus, there are many public locations, such as large office buildings, parking garages, subways, etc. where the GNSS satellite signals are not available and GNSS receivers do not function properly. This can be of serious concern, especially in the case of public safety operations, where GNSS receivers may be used to direct emergency responders to the location of a person in distress. Without enhanced coverage, the potential applications of such global navigation satellite technology may be severely limited.

### SUMMARY

Aspects of the present invention address one or more of the issues mentioned above, thereby providing for enhanced coverage of global navigation satellite systems. At least one aspect of the present invention provides a GNSS emitter device that broadcasts GNSS signals over a small geographical area in locations where the GNSS signals would not otherwise be available. This enables GNSS receivers to operate and provide location information in a wider variety of areas. In some aspects of the invention, a GNSS antenna collects GNSS signals and forwards the signals to GNSS emitter devices through a signal distribution network. The signal distribution network may or may not include additional signal processing (for instance, signal amplifiers and/or repeaters). In one example, such a network may include at least a coaxial cable network. The broadcast signal may be such that the signals may possess relative chipping code phases and Doppler frequencies that correspond to the known location of the signal emitter's antenna, accurate GNSS satellite constellation time, and navigation data information, and may correspond to the list of GNSS satellites that would be visible at the known location were the authentic GNSS signals not obscured.

These and other aspects of the invention are addressed in relation to the Figures and related description.

### BRIEF DESCRIPTION OF THE DRAWINGS

The foregoing summary of the invention, as well as the following detailed description of the preferred embodiments, is better understood when read in conjunction with the accompanying drawings, which are included by way of example, and not by way of limitation with regard to the claimed invention, wherein:

FIG. 1 illustrates a conventional Global Navigation Satellite System (GNSS) that may support one or more aspects of the present invention.

FIG. 2A illustrates a synchronous GNSS emitter system environment according to one illustrative embodiment of the present invention.

FIG. 2B illustrates an autonomous GNSS emitter system environment according to another illustrative embodiment of the present invention.

FIG. 2C illustrates a GNSS emitter system environment according to a further illustrative embodiment of the present invention.

FIGS. 3A and 3B are diagrams of GNSS emitters according to an illustrative embodiment of the present invention.

FIG. 4 is a view of the constellation information collection and distribution mechanism for providing constellation information to a multi-emitter system according to an illustrative embodiment of the present invention.

FIG. 5 illustrates another embodiment of the present invention wherein the constellation information collection and distribution mechanism is a computer network.

FIG. 6 is a diagram of a multi-emitter system according to an illustrative embodiment of the invention wherein the constellation information collection and distribution mechanism is an analog radio frequency signal distribution network.

FIG. 7 is diagram of an individual emitter unit according to an illustrative embodiment of the invention.

FIG. 8 is a diagram of an individual emitter unit according to another illustrative embodiment of the present invention.

### DETAILED DESCRIPTION

The present invention will now be described more fully hereinafter with reference to the accompanying drawings, in which various aspects of the invention are shown. This invention may, however, be embodied in different forms and should not be construed as limited to the embodiments set forth herein. Rather, the embodiments are provided so that this disclosure will be thorough and complete, and will fully convey the scope of the invention to those skilled in the art. The elements and drawings are not necessarily to scale, emphasis instead being placed upon clearly illustrating the principals of the present invention.

For purposes of this disclosure, “reconstructed signals” may include reconstruction of signals with slight modifications to signal components, replacement of one or more signal components, and complete replacement of all signal components. Reconstructing signals may be referred to as modifying signal characteristics. Also, it is noted that various connections are set forth between elements in the following description. It is noted that these connections in general and, unless specified otherwise, may be direct or indirect and that this specification is not intended to be limiting in this respect.

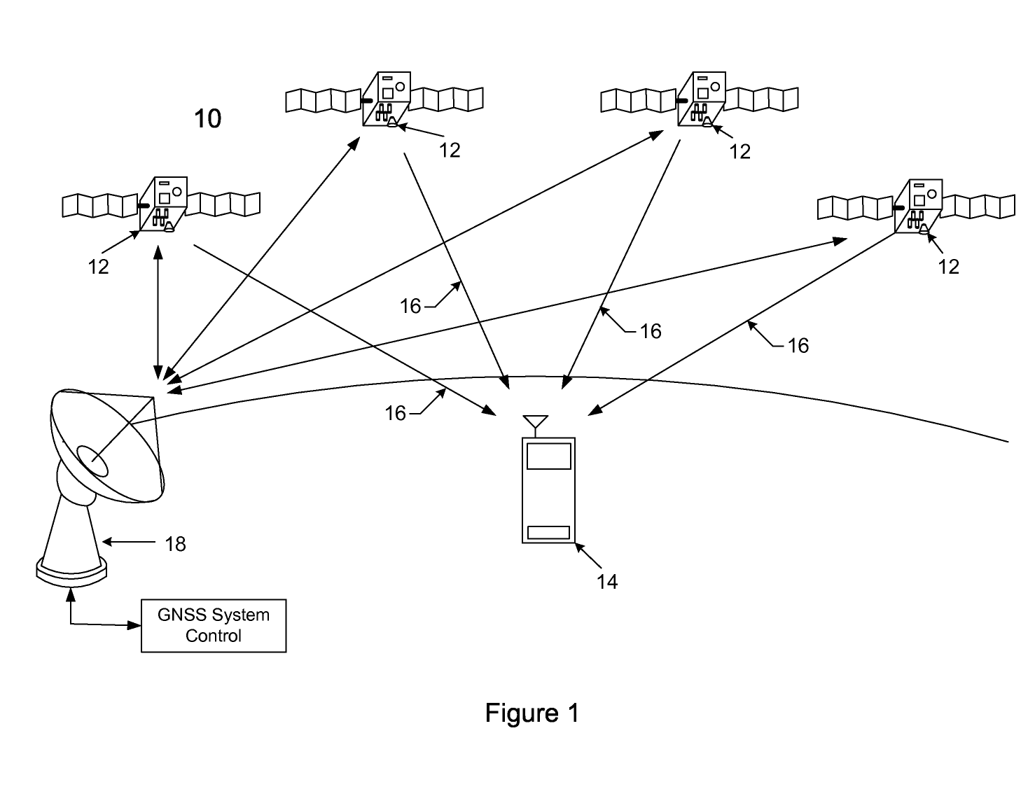

FIG. 1 illustrates a conventional Global Navigation Satellite System (GNSS) 10 that may support one or more aspects of the present invention. GNSS systems are space-based triangulation systems that consist of multiple radio navigation satellites 12 and a ground control segment 18. The satellites 12 support the operation of navigation and location receivers 14, e.g., a radio receiver with a time correlator processor, by the continuous transmission of radio navigation signals 16. GNSS receivers 14 operate by receiving these radio signals from the satellites and, using a time correlation process, measure the time it takes for the signals 16 to travel from the GNSS satellites 12 to the receiver's location. By multiplying the travel time by the speed of light, the receiver 14 can determine the range to the satellite and thereby determine its location through triangulation.

As the GNSS satellites 12 orbit the earth, they emit radio navigation signals 16 synchronously according to GNSS system time. The signals 16 possess certain spread spectrum properties that allow the receiver 14 to measure the signal's time of arrival at the receiver's location. In addition to the spread spectrum properties, the signals 16 also contain a digital data steam, referred to as navigation data, that includes parameters describing the GNSS constellation orbital patterns as well as the GNSS system time. With the orbital parameters and system time, the GNSS receiver 14 can calculate the location of a satellite 12 in space at the moment the spread spectrum signal 16 was broadcast from the satellite 12. With knowledge of the satellite's position and system time when the signal 16 was broadcast, the receiver 14 can use this information along with the signal's time of arrival to determine the time of flight of the signal 16. Multiplying by the speed of light and adjusting for certain atmospheric propagation effects, the receiver 14 can determine the range to the satellite 12. Once this process has been completed for three or more satellites 12, the receiver 14 can use a triangulation technique to calculate its location on or near the surface of the earth.

The spread spectrum signals used by GNSS satellites 12 may be created by multiplying the carrier signals with binary codes, referred to as “chipping codes,” which may be of a predetermined frequency and length, and which may also possess unique mathematical properties. These chipping codes may be such that if one code of the family of codes is time correlated with another code of the same family, the result will be zero correlation. Furthermore, a chipping code time correlated with a shifted version of the same code may also result in zero correlation so long as the code is shifted by more than +/− one chip. The time correlator output in the GNSS receiver 14 may only produce a non-zero result, i.e. a correlation peak, when a code is correlated with a copy of the same code and at the exact moment that the two copies are aligned. Such a method allows a GNSS receiver 14 to measure the time that a satellite signal 16 is received. Since the codes may be repeated continuously in the satellite signal 16, it can be said that the receiver 14 is measuring the code phase of the signal 16 when it arrives at the receiver's location.

As has been described, GNSS receivers may operate by searching the received signal for specific satellite chipping codes and measuring the phase of those codes at the receiver's location. Since GNSS constellations may include many satellites 12 that orbit the earth continuously, a GNSS receiver may have a limited prior knowledge of which GNSS satellites 12 are overhead and which satellite chipping codes it should be searching for. Such knowledge is, in fact, stored in most GNSS receivers 14 and is referred to as an almanac. The almanac information may be pre-stored or derived and/or downloaded downstream and use of this almanac may depend on the mode of operation (e.g., synchronous or autonomous). For example, the almanac information may be downloaded through RF or IR transmissions, LANs or Internet networks. With a basic knowledge of system time, which may be accomplished by, for example, a real time clock (RTC), an assumption about the receiver's approximate location (which may or may not be based on the receiver's last known location), and the almanac information, a GNSS receiver 14 that has just been enabled may be able to calculate the list of satellites 12 and the corresponding chipping codes that it should search for in the received signal 16. Although the almanac and inaccurate system time kept in the receiver 14 are often insufficient to calculate a location for the receiver 14, this information is sufficient to significantly reduce the time required for a standard GNSS receiver 14 to find, or acquire, the satellite codes in the received signals.

Another type of GNSS receiver 14, referred to as assisted, may acquire the GNSS satellite signals 16 without the requirement of maintaining an almanac, the last know position, and the GNSS system time within the receiver 14. For assisted receivers, this information may be delivered to the receiver 14 by means of another communications link, such as but not limited to a wireless cellular network. In such assisted systems, a computer network server within the communication network may have access to current information about the satellites overhead by communicating with other GPS receivers 14 that are near the assisted receiver's location. The computer network server may then communicate the system time and satellite list to the receiver so that it may conduct a narrower search for the satellite codes, resulting in faster acquisition and improved receiver sensitivity.

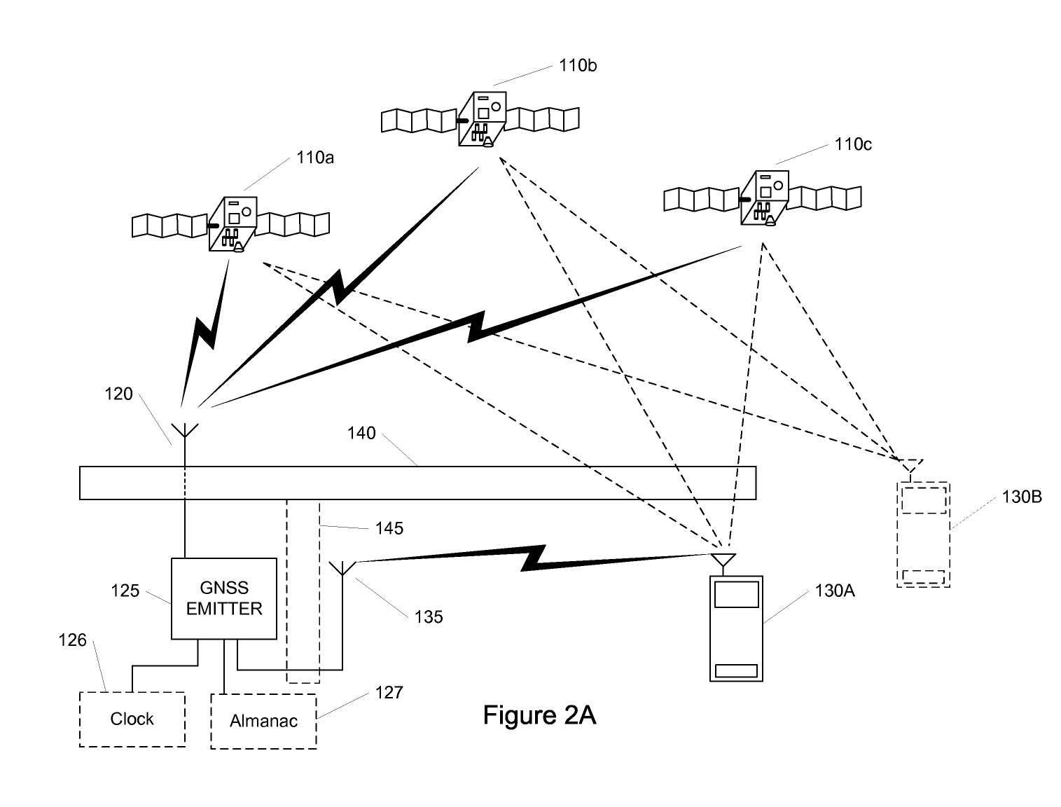

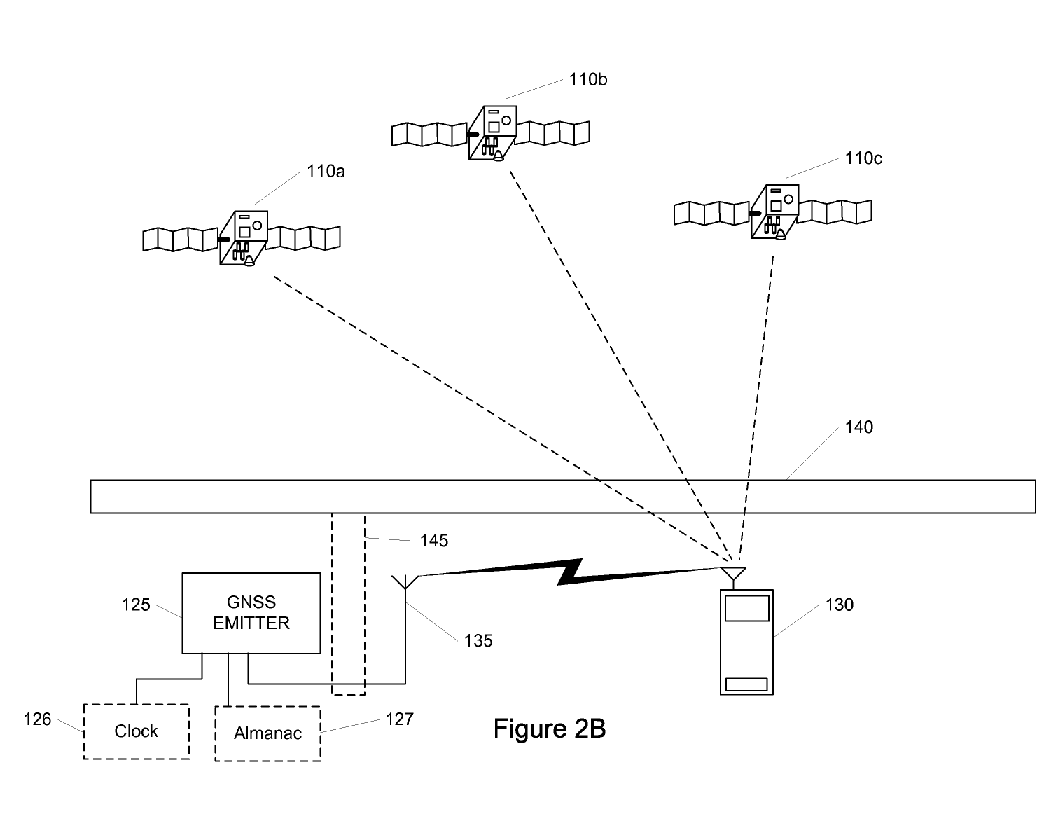

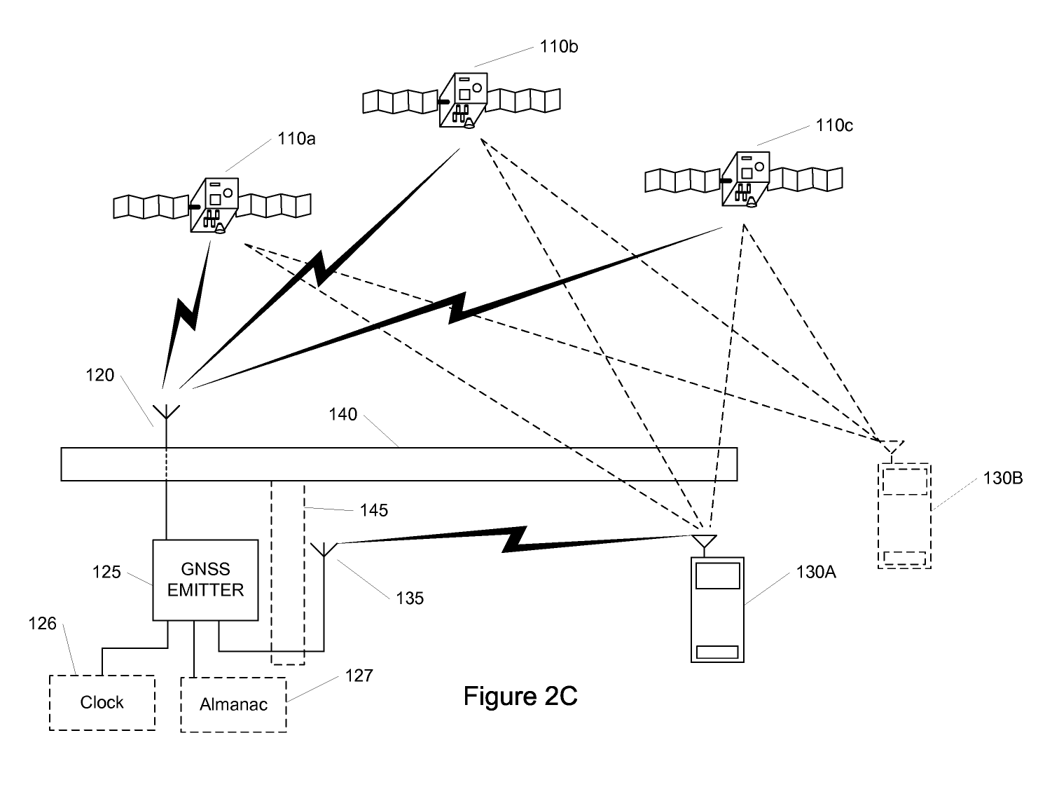

GNSS emitters may operate in different modes including an autonomous mode and a synchronous mode. For example, FIGS. 2A-2C, a GNSS emitter may be engaged in autonomous operation or synchronous operation. It is appreciated that a GNSS emitter may be limited to operating in a synchronous mode as shown in FIG. 2A, may be limited to operating in an asynchronous mode as shown in FIG. 2B, or may have the ability to operate in both modes as shown in FIG. 2C. Signals may be output from a GNSS emitter where the signals include components. Reconstructed signals may include reconstruction of one or more components.

As shown in FIG. 2A, a GNSS emitter may operate in a synchronous mode. A GNSS emitter 125 receives via receive antenna 120 transmissions from satellites 110a-110c. The GNSS emitter reconstructs the received signals and transmits the reconstructed signals using antenna 135 to GNSS receiver 130A (at a position obstructed by obstruction 140). The system shown in relation to FIG. 2A is described as synchronous in that the signals transmitted from antenna 135 have timing signals that are synchronous with those from satellites 110a-110c. GNSS receiver 130A may eventually move from a position obstructed by obstruction 140 to another position (represented by receiver 130B shown in broken lines) where the receiver 130B may receive the signals from satellite 110a-110c in an unobstructed fashion.

The signal or signals being emitted by antenna 135 may be synchronized to GNSS conditions that would exist at the precise location of antenna 135 were the signals from the satellites 110a-110c not otherwise obstructed. Synchronous operation may enable a receiver 130A that is receiving signals from the GNSS emitter antenna 135 to transition to receiving signals from the satellites 110a-110c, without a significant disruption in operation, by moving from an obstructed position to an unobstructed position or from an unobstructed position to an obstructed position. Conversely, synchronous operation may also enable a receiver 130A that is receiving signals from the satellites 110a-110c to transition to receiving signals from the GNSS emitter antenna 135, without a significant disruption in operation, by moving from an unobstructed position to an obstructed position.

GNSS emitter 125 may or may not include a clock 126 and/or an almanac 127 (both shown in broken lines to highlight their optional nature). Clock 126 and almanac 127 may be incorporated into the structure of GNSS emitter 125, may be external to GNSS emitter 125, or may have their information provided by a remote source. For instance, almanac 127 may be a CD-ROM, flash memory, or any other memory (internal or external to GNSS emitter 127) that may provide the almanac 127 to GNSS emitter 127. Further, almanac may be provided over a network to GNSS emitter 125, including but not limited to an RF network, IR network, and a wired network. Other network variations are possible.

Obstruction 145 is also shown as an alternate or addition to that of obstruction 140. There is no requirement of the location of GNSS emitter 125 as being in direct line of site for either satellites 110a-110c or GNSS receiver 130A.

Signals from the GNSS emitter unit 125 may possess certain properties that correspond to the original satellite signal properties that would be observable at the location of the GNSS receiver 130 if the signals were not obstructed. The properties of the signals from the GNSS emitter unit 125 that correspond to the signals from the original satellites, if those signals were not obstructed at the location of the GNSS receiver 130, may include the same GNSS satellite pseudo-random code list, relative pseudo-random code phases, Doppler frequencies, navigation data (potentially delayed in time), and GNSS system time. The GNSS emitter units may collect the properties of the original satellites signals from a receiver antenna 120 placed in an unobstructed position, as is shown in FIG. 2A. The unobstructed position 130B may be distinct from or at the same location of the GNS receiver 130. Signals from the satellites 110a, 110b, and 110c may then be received at the antenna 120 and relayed to a GNSS emitter unit 125 through a distribution network. Upon receiving the signals from the receiver antenna 120, the GNSS emitter 125 may extract relevant constellation information from the signal and modify one or more properties of the signals, according to a knowledge of the emitter's antenna 135 location, before reconstructing the signal for retransmission. Once the signal parameters have been modified, the GNSS emitter may subsequently output a reconstructed signal through an emitter antenna 135 to the GNSS receiver 130. The reconstructed signal may include one or more components that were modified and/or completely replaced.

As shown in FIG. 2B, a GNSS emitter may operate in an autonomous mode, the GNSS emitter may operate independently without the requirement for a receiver antenna 120 placed in an unobstructed position and without aligning the emitter's time with GNSS satellite time. The GNSS emitter 125 in autonomous operation may or may not include a clock 126 and an almanac 127 as described above. The clock 126 (which may or may not be a Real Time Clock as described below) and the almanac 127 may be used to create signals that correspond to satellites that are known to be visible from a given location. Clock 126 and almanac 127 are shown in broken lines indicating that they may or may not be used with a given emitter. Their functions may be incorporated into the circuitry in emitter 125 or may be supplied from outside emitter 125. Using the information from almanac 127, a signal generator of the emitter 125 is able to generate appropriate signals for the receiver 130 and broadcast them via an antenna system 135. The generated signals may or may not be in synchronism with the signals from satellites 110a-110c.

GNSS emitter 125 may receive as input a location for which it will emulate the signals receivable at that location. By varying the input location, one may provide receiver 130 with a number of signals that correspond to varying locations. This testing may enable one to test receiver 130 to determine whether it 1) responds properly by determining the new locations and 2) optionally responds properly to detecting its location (for instance, determining that the receiver is in a restricted airspace after determining its location). Using this system, one may test receivers 130 without having to physically transport the receivers to a location for testing.

Further, clock 126 and almanac 127 may be preloaded into GNSS emitter 125 or may be downloaded at a later time (including but not limited to prior to installation, during installation or after installation). The downloading may be performed through the use of connecting the GNSS emitter 125 to a computer network, either wirelessly or in a wired fashion, receiving broadcast RF signals, and the like.

A GNSS emitter 125 may have sufficient flexibility to shift between autonomous operation and synchronous operation. Alternatively, the GNSS emitter 125 may operate in both modes as is illustrated in FIG. 2C. In such an instance, the GNSS emitter 125 may use information from both stored data (clock and almanac) as well as satellite signals received via an unobstructed antenna system 120.

In yet a further aspect of the synchronous system as shown in FIG. 2C, the GNSS emitter 125 may or may not include a GNSS receiver antenna 120. Rather, the information regarding the satellites overhead (110a-110c) and the timing relative to those satellites may be provided, for example, via a computer network.

As will be described below, one or more aspects of the invention may use the features of the GNSS systems described above. The following is separated into autonomous and synchronous operation. The features and structures that follow may be implemented separately or together, to various degrees.

Operation Types

Autonomous Operation

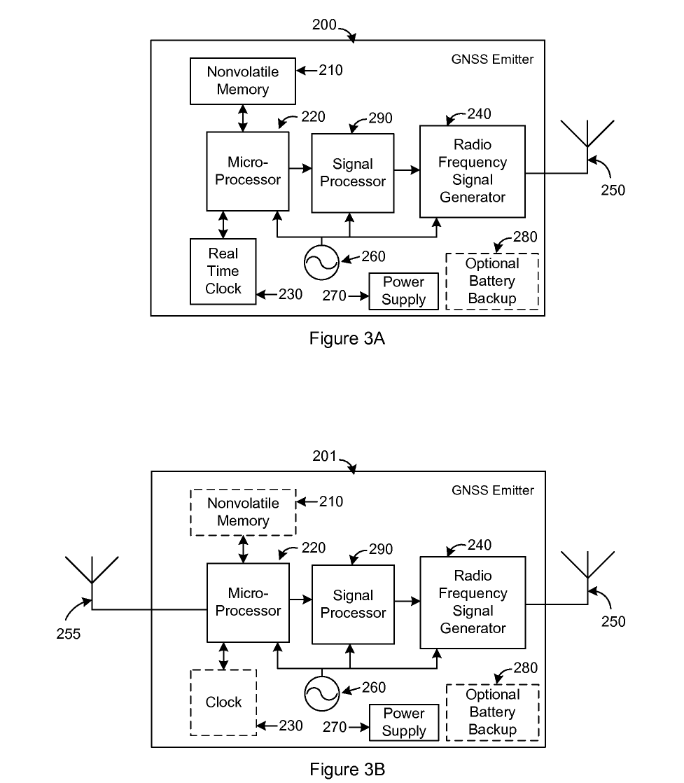

With reference to FIG. 3A, in one embodiment of the invention, the GNSS emitter 200 may operate as a single unit autonomously, that is, without continual input of current constellation information. However, in this mode of operation, the GNSS emitter real time clock 230 may develop a timing error and thus the GNSS emitter may not be compatible with some assisted GNSS receivers which are provided with very accurate GNSS time from an external source. If the system time in the GNSS emitter is not aligned with the actual GNSS constellation system time, the assisted GNSS receiver may remain in an unsynchronized state or may attempt to reacquire based on timing of the actual satellite system. For instance, the GNSS receiver may conduct narrow searches for code phases that are different than the code phases emitted by the GNSS emitter. Consequently, an assisted GNSS receiver may never find the GNSS emitter or the acquisition time may be significantly prolonged.

FIG. 3A illustrates a GNSS emitter 200 according to one illustrative aspect of the present invention. The GNSS emitter 200 includes a baseband processor subsystem, including a Non-volatile memory 210, a Real Time Clock 230, a micro-processor 220 and a signal processor 290. The micro-processor 220 function and the signal processor 290 function may include multiple circuits or be realized in one processor circuit (such as ASICs, FPGAs and the like). The GNSS emitter 200 may also include a Radio Frequency Signal Generator 240 and a reference frequency oscillator 260. The reference frequency oscillator 260 may provide a master clock to the baseband processor subsystem and Radio Frequency Signal Generator 240. Alternatively, two or more oscillators may be used as a frequency source to various ones of the microprocessor 220, the signal processor 290, and the radio frequency signal generator 240. Furthermore, the GNSS emitter 200 may include a power supply 270 that conditions the voltage or voltages available from local power source(s) to the voltages required for operation of the GNSS emitter system 200. In the event that there is a disruption of service from the local power source, an optional backup battery system 280 may also be used to ensure continued operation.

The GNSS emitter 200 may be an emitter that outputs signals that may be received at distances over 100 m. Alternatively, GNSS emitter 200 may also be a low-power emitter that only radiates enough energy such that only GNSS receivers located close to (100 m or less) the low powered GNSS emitter can accurately receive the signal.

The information that may be used to calculate the GNSS signal characteristics that relate to the GNSS emitter's location may include a GNSS system almanac, the GNSS emitter's location, and GNSS system time. The characteristics may include pseudo random code that includes phases and Doppler frequencies and may further include navigational data seperate from the pseudorandom codes.

The mechanism for storage of the almanac and the GNSS emitter's location may include a Non-Volatile Memory (NVM) 210. In instances where the storage of the almanac and GNSS emitter's antenna location does not include NVM, the volatile memory can be refreshed if there is a power failure. In an autonomous operating mode, the GNSS system almanac may be pre-stored or associated with the GNSS emitter 200 at a later time. The source of the GNSS system time may include the GNSS emitter's Real Time Clock (RTC) 230. The mechanism for controlling operation of the GNSS emitter may include a micro-processor 220, and the mechanism for calculation of the signal to be output from antenna 250 with the modified characteristics may include a compact, low cost digital processor 290. The micro-processor 220 function and the signal processor 290 function may be realized in one processor circuit. Alternatively, the microprocessor 220 function and the signal processor 290 function may be realized in two or more processor circuits. The mechanism for generation of the signal with characteristics may include a radio frequency signal generator 240. The mechanism for broadcast of the signal with characteristics may include an antenna system 250. The GNSS emitter units 200 may operate autonomously to provide GNSS signals that relate to one specific location, the location where the GNSS emitter unit's antenna 250 is installed, or another location as specified by the operator. There is no requirement that the GNSS emitter's time be accurately aligned to the actual GNSS satellite system time.

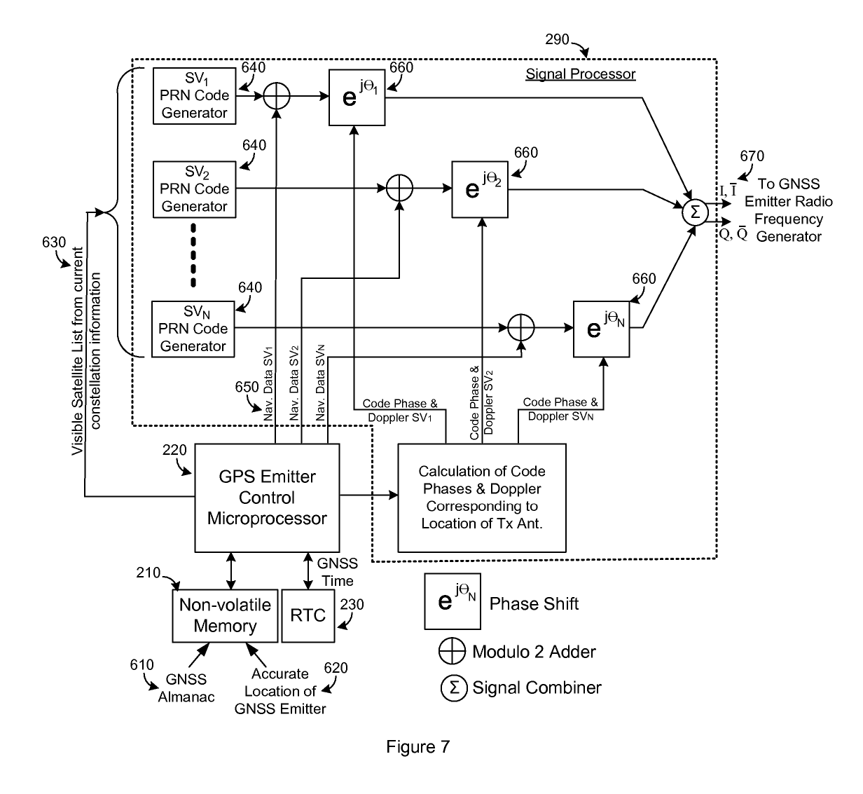

With reference to FIG. 7, the GNSS emitter 200 operates as follows. Upon installation of the GNSS emitter, the location of the emitter's antenna 620 and the current almanac information 610 may be programmed into the Non-volatile memory 210 of the baseband processor subsystem. Also during installation, the GNSS system time may be programmed into the GNSS emitter's Real Time Clock 230. Once the GNSS emitter is enabled, the location, system time, and GNSS satellite almanac information may be used to determine the list of satellites 620 that would otherwise be visible at that time and location were the actual GNSS satellite signals not obstructed. This satellite list may be used within the signal processor 290 to create chipping code generators 640 and navigation data streams 650 for each satellite in the list. Once the satellite chipping codes have been created and the navigation data has been added, the phase and frequency of the chipping code may be adjusted with phase shifters 660 according to the phase and Doppler frequencies that would correspond to the GNSS system time and the location of the GNSS emitter. Once the satellite chipping codes have been generated with the appropriate navigation data, phase, and Doppler frequencies that correspond to the GNSS system time and emitter's antenna location, the chipping codes may be summed and output to the GNSS emitter Radio Frequency Signal Generator 240 in the proper format 670 to drive an I/Q modulator.

Note also that for the current embodiment, the GNSS emitter 200 may have limited compatibility with GNSS receivers that require navigation from one GNSS emitter 200 to the next. In this scenario, the GNSS receiver may be tracking the code phases from a specific GNSS emitter. In order that the GNSS receiver can transition from the current GNSS emitter to the next emitter, the code phases for the next emitter may need to be aligned with the code phase of the original. Consequently, if multiple GNSS emitters are distributed along a route that a GNSS receiver must navigate (e.g. a subway system), the GNSS emitters that make up this system may be synchronized to GNSS system time so as to ensure that a receiver may navigate from one GNSS emitter to the next or even from the authentic GNSS signals into an area where GNSS emitters are located. The degree of alignment may be flexible to the extent that GNSS receivers may be able to transition between responding to signals from emitters to signals from GNSS satellites without undue delay.

Synchronous Operation

FIG. 3B shows a GNSS emitter 201 operating in a synchronous mode. While similar to the description of FIG. 3A above, FIG. 3B includes a receiving antenna 255 (or other input) by which to receive current satellite signal information relevant to given location. GNSS emitter 201 may not normally include both of NVM 210 and clock 230. Alternatively, one or more of these components may be included or functions provided to GNSS emitter 201 through an electrical connection (direct—for instance, USB—or remotely—for instance, over a network). As described above with respect to FIG. 3A, the GNSS emitter 201 may have one or more oscillators 260, an optional battery backup, processors and signal generators combined onto one or more chips, and the like.

Computer Network

In this embodiment, multiple GNSS emitters may be synchronized to the GNSS conditions that would exist at a specific location were the GNSS signals not obstructed, enabling compatibility with assisted GNSS receivers and standard navigating receivers. The following describes a system that distributes current GNSS constellation information to the multiple GNSS emitters.

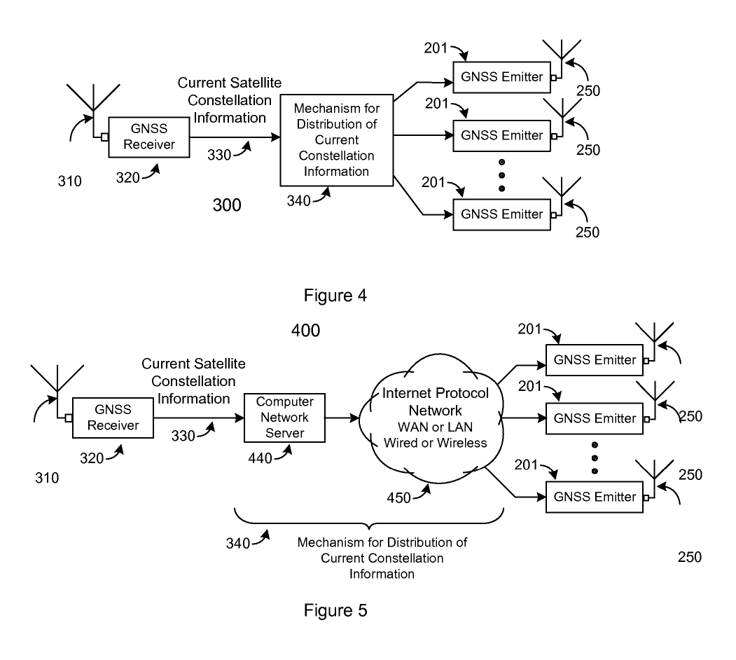

FIG. 4 illustrates a GNSS system for collecting current constellation information according to an illustrative embodiment of the present invention. The mechanism for the collection of the current constellation information may include a standard receiver antenna 310 and an application specific receiver 320. Application specific receivers 320 may include GNSS receivers that are compatible with a particular satellite system. Examples of such satellite systems may include the Global Positions System, Galileo and GLONASS. The application specific receiver 320 may be configured to collect and output specific information 330 that is required to generate the signals that correspond to the location(s) of the one or more emitter unit(s) antenna(s) 250 (see FIG. 2 for additional information on GNSS emitter units). Furthermore, mechanisms exist for the distribution of the current constellation information 340 as will be discussed below. If the current constellation information is available through mechanism 340, the GNSS emitter units 201 may then use current constellation information and GNSS emitter's antenna location to compute and generate the GNSS signals with the required characteristics, rather than using internally stored almanac and internally generated time.

FIG. 5 illustrates a detailed view of the constellation information collection mechanism according to an illustrative embodiment of the present invention. One mechanism for distribution of the current constellation information 340 may be a computer network server 440 and computer based network 450. The computer based network 450 may further include a wired or wireless a Local Area Network (LAN) or Wide Area Network (WAN). Examples of LANs and WANs may include Ethernet and token ring networks.

In further reference to FIG. 5, a GNSS receiver 320 may collect signals from the GNSS constellation by way of a GNSS receive antenna 310 located in clear view of the GNSS satellite signals. The GNSS receiver 320 may collect and output specific constellation information 330, such as system time, satellite visibility list, satellite chipping codes phases and Doppler frequencies and navigation data. In one example, the current constellation information may be passed to the GNSS emitter units 201 by way of a computer network server 440 and a computer network 450. The GNSS system time information may be delivered by way of a time transfer protocol (for instance, the precise time transfer protocol) in order to maintain synchronization throughout the system of GNSS emitters.

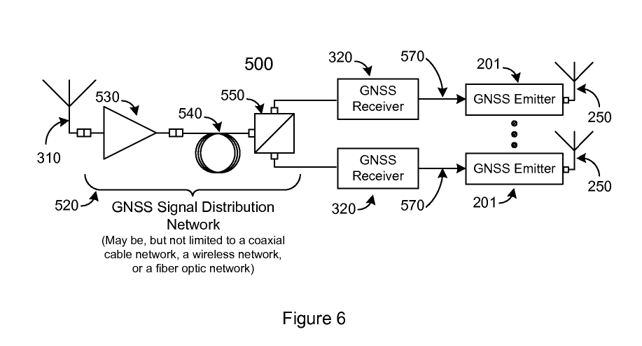

FIG. 6 illustrates application specific GNSS receivers in combination with a GNSS signal distribution network according to an illustrative embodiment of the present invention. The application specific GNSS receivers 320 may be located at the site and potentially integrated inside of the emitter unit(s) 201. The mechanism for distribution of the current constellation information may include a Radio Frequency distribution network 520 that distributes the received signal from the satellite constellation by either a coaxial cable network (as shown), an analog fiber optic network, or an analog wireless network. In one example, the information necessary for generation of the GNSS signal with the desired characteristics is provided from the GNSS receiver 320 directly to the signal processor of the GNSS emitter unit 201. Alternatively, such information may also be provided from the GNSS receiver 320 to the signal process of the GNSS emitter unit 201 through indirect methods.

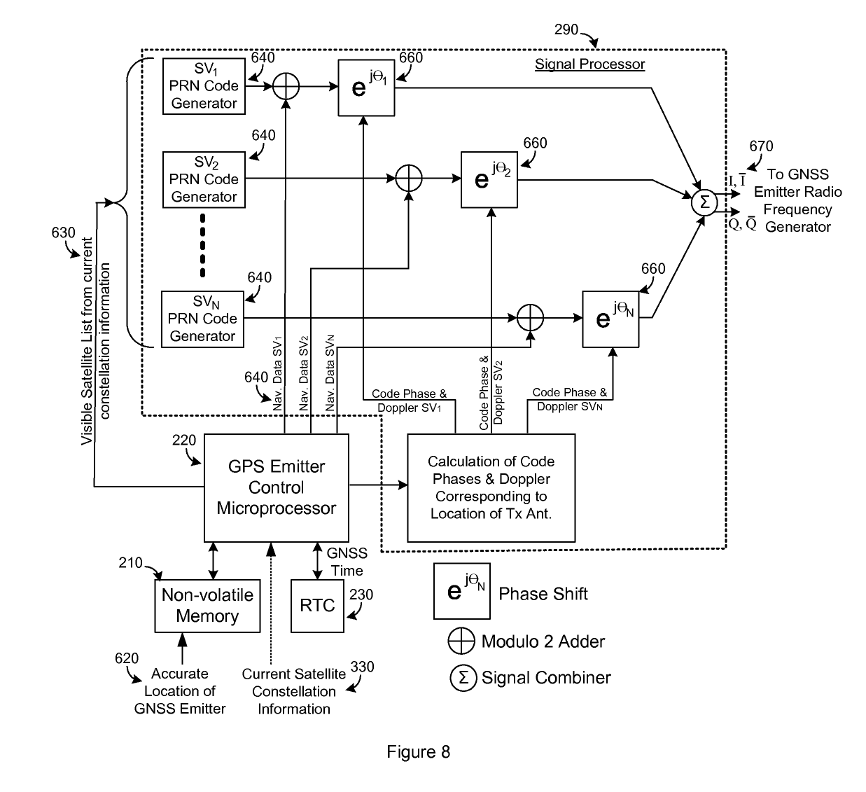

Once the current constellation information 330 has been delivered to the individual GNSS emitter units 201, the GNSS emitter units generate the signals with the appropriate signal characteristics in a manner similar to the previous autonomous operation embodiment. Referring to FIG. 8, rather than basing the computation of signal characteristics on internally stored almanac and internally generated time, computation of the signal characteristics for this embodiment may instead be based on current constellation information 330 received from the information distribution network 340.

RF Network

In this embodiment, multiple GNSS emitters may be synchronized to the GNSS conditions that would exist at a specific location were the actual GNSS signals not obstructed, enabling compatibility with assisted GNSS receivers and standard navigating receivers. In this embodiment, the implementation overcomes the requirement for a time transfer protocol as was the case in the previous embodiment. With reference to FIG. 6, this embodiment includes a GNSS antenna 310 that collects the GNSS radio frequency signals from the satellites. The radio frequency GNSS signals are distributed to the GNSS receivers 320 by way of a GNSS Signal Distribution Network 520. The GNSS Signal Distribution Network, if realized by way of a coaxial cable network may include low noise amplification 530, low loss coaxial cables 540, and GNSS signal dividers 550. Further embodiments of the design could realize the radio frequency GNSS Signal Distribution Network 520 by an analog wireless network or by an analog fiber optic network. Whatever the means for distributing the GNSS radio frequency signals, once the signals have been delivered to the GNSS receiver 320, the receiver may collect and output specific constellation information 330, such as system time, satellite visibility list, satellite chipping codes phases and Doppler frequencies and navigation data. The current constellation information from the receiver may be passed to the GNSS emitter unit's micro-processor 220 by way of serial or parallel digital interface 570.

Once the current constellation information 330 has been delivered to the individual GNSS emitter units 201, the GNSS emitter units may generate the signals with the appropriate signal characteristics in a manner similar to the previous autonomous operation embodiment. Referring to FIG. 8, rather than basing the computation of signal characteristics on internally stored almanac and internally generated time, computation of the signal characteristics for this embodiment may instead be based on current constellation information 330 received from the GNSS receiver 320 at the GNSS emitter's antenna location.

In all previous embodiments of the present invention, the GNSS emitter units 201 may include an internal backup battery system (see FIG. 3, 280) that enables continued operation in the event of a power failure or interruption from the normal power supply 270, which is a high probability in the case of an emergency scenario. Alternatively, the emitter units 201 may lack battery power.

Aspects of the invention including, but not limited to, microprocessors, signal processors, and radio frequency signal generators may be implemented in hardware and/or software, including, but not limited to, ASICs, FPGAs, and the like.

Furthermore, the above-described illustrative embodiments of GNSS emitter system may be combined with other systems. In addition to being usable with active satellite signals, aspects of the GNSS emitter system may incorporate simulated signals and signals from pseudolites. For example, if a GNSS receiver antenna was located in a position where it could only acquire signals from two satellites, the GNSS emitter system may employ a satellite outpost. The satellite outpost may be positioned to receive signals from a third satellite and transmit those signals to the GNSS receiver antenna.

While the present invention has been described with reference to illustrative embodiments, it will be understood by those of ordinary skill in the art that various changes may be made and equivalents may be substituted for elements thereof without departing from the scope of the invention. In addition, many modifications may be made to adapt a particular situation or material to the teachings of the invention without departing from the scope thereof. Different hardware may be used than that shown and suggested that may include hardware, firmware, or software implementations of the present invention. Therefore, it is intended that the invention not be limited to the particular embodiments disclosed, but that the invention include all embodiments falling within the scope of the appended claims.

What is claimed is:

1. A method for providing GNSS signals to GNSS receivers where said GNSS receivers receive less than a desired number of GNSS signals from GNSS satellites having a minimum signal quality, said method comprising the steps of:
receiving a signal from a GNSS satellite through a GNSS receiver antenna, wherein the received signal from the GNSS receiver antenna includes constellation information;
determining a list of satellites from the constellation information;
creating a satellite chipping code corresponding to the list of satellites;
modifying signal characteristics; and
outputting a signal having said modified signal characteristics to said GNSS receiver.

2. The method according to claim 1, wherein said signal characteristics include pseudo random code that includes phase information and Doppler frequency information and includes navigational information of said GNSS satellite, said pseudo random code and said navigational information correlated to a specific location and specific time of a GNSS system.

3. The method according to claim 2, said modifying step further comprising:
modifying said phase information;
modifying said Doppler frequency information; and
temporarily buffering said navigational information.

4. The method according to claim 2, said modifying step further comprising;
receiving location information;
reconstructing said signal characteristics to reflect reception of said signal from said GNSS satellite at said location.

5. The method of claim 1, wherein said signal characteristics includes a time parameter.

6. The method of claim 2, wherein the step of modifying step further comprises:
accounting for a delay between a time associated with the received signal and a time associated with the outputted signal.

7. The method of claim 6, wherein the step of modifying further comprises:
accounting for a propagation delay between the GNSS emitter's receiving antenna and the GNSS emitter's transmit antenna.

8. A method for providing GNSS signals to a GNSS receiver, where said GNSS receiver receives less than a desired number of GNSS signals from GNSS satellites having a minimum signal quality, said method comprising the steps of:
receiving a data at an emitter, wherein the data includes a location and almanac information;
determining a list of satellites from the location, almanac information and a system time;
creating signal characteristics including a pseudo random code with phase information and Doppler frequency information and navigation information corresponding to the list of satellites; and
outputting a signal having said signal characteristics to said GNSS receiver via an emitter antenna.

9. The method according to claim 8, wherein said signal characteristics correlate to a said location and said time.

10. The method according to claim 8, wherein said location is the location of said emitter transmit antenna.

11. The method according to claim 8, wherein said location is not the location of said emitter transmit antenna.

12. A global navigation satellite system emitter comprising:
a non-volatile memory storing a location;
a clock for maintaining a system time;
a microprocessor that determines information to include in a GNSS signal based on said location and said system time;
a signal processor that creates signals that include said information;
a GNSS radio frequency signal generator that generates GNSS signals based on signals from said signal processor; and
a GNSS antenna system for broadcasting said GNSS signals.

13. The global navigation satellite system according to claim 12, further comprising:
a receiving antenna receiving GNSS signals from at least one satellite,
wherein said microprocessor determines said information based at least in part on said GNSS signals from said receiving antenna, said information including phase and Doppler frequency information.

14. The global navigation satellite system according to claim 12,
wherein said non-volatile memory includes an almanac and
wherein said microprocessor determines said information from said location, said system time, and said almanac, said information including phase and Doppler frequency information.

15. The global navigation satellite system emitter of claim 12, further comprising a distribution network that distributes said GNSS signals to at least two GNSS emitters.

16. The GNSS emitter of claim 12, further comprising a backup battery system to enable continued operation in the event of an interruption of power from a power source.

17. A GNSS emitter system comprising:
a GNSS receiver antenna for collecting one or more GNSS constellation signals;
a GNSS receiver for processing said one or more GNSS constellation signals from said receiver antenna and extracting current constellation information;
one or more GNSS emitters; and
a mechanism for distributing said current constellation information to said one or more GNSS emitter units.

18. The GNSS emitter system of claim 17, wherein the one or more GNSS emitters further comprise:
a non-volatile memory for storage of a GNSS satellite constellation almanac and a location of said GNSS emitter unit's transmit antenna;
a clock for maintaining actual GNSS system time;
a processing unit for performing one or more tasks, wherein said one or more tasks includes at least one of communicating with said mechanism for distribution of current constellation information, managing operation of said GNSS emitter, calculating a satellite list based on said current constellation information and GNSS system time from said clock, wherein the processing unit is further configured for computing GNSS signals based on said GNSS emitter's antenna location and on said current constellation information from said mechanism, wherein said signals have characteristics that relate to said GNSS emitter's antenna location and said actual GNSS system time;
a GNSS radio frequency signal generator for generation of said GNSS signals; and
a GNSS antenna system for broadcast of said GNSS signals.

19. The GNSS emitter system according to claim 17, wherein said processing unit includes at least two of a microprocessor, a signal processor, and radio frequency signal generator.

20. The GNSS emitter system according to claim 17, wherein said processing unit includes at least two of a microprocessor, a signal processor, and a radio frequency signal generator on a single chip.

21. The GNSS emitter system of claim 17, further comprising a backup battery system to enable continued operation in the event of an interruption of power from the external source.

22. The GNSS emitter system of claim 17, wherein said mechanism for distribution of current constellation information is a computer network further comprising:
a computer network server; and
a computer network.

23. The GNSS emitter system of claim 17, further comprising:
a GNSS signal distribution network that distributes GNSS constellation signals collected through said GNSS antenna to one or more GNSS receivers.

24. The GNSS emitter system of claim 17, wherein said GNSS signal distribution network further comprising:
a coaxial cable network including one or more coaxial cables.

25. The GNSS emitter system of claim 24, wherein said coaxial cable network further includes one or more amplification devices.

26. The GNSS emitter system of claim 24, wherein said coaxial cable network further includes one or more signal distribution devices.

27. The GNSS emitter system of claim 17, wherein said GNSS signal distribution network, comprising:
a fiber optic network, further comprising:
an analog radio frequency fiber optic transmitter for conversion of GNSS signal to light frequencies for transmission over fiber optic network;
one or more fiber optic cables; and
one or more analog radio frequency fiber optic receivers for receiving said GNSS signals which have been converted to light frequencies for transmission over fiber optic network and conversion of said GNSS signals back to original frequencies.

28. The GNSS emitter system of claim 17, wherein said GNSS signal distribution network further comprises:
an analog wireless network including
an analog wireless radio frequency transmitter for conversion of GNSS signal to frequencies for transmission over wireless radio network;
an antenna system for broadcast of said GNSS signals over wireless radio network;
one or more antenna systems for receiving of said GNSS signals over wireless radio network; and
one or more analog wireless radio frequency receivers for the purpose of receiving said GNSS signals which have been converted to frequencies for transmission over wireless radio network and for conversion of said GNSS signals back to original frequencies.

29. The GNSS emitter system of claim 17, wherein the clock in said individual GNSS emitters is updated with accurate GNSS system time taken from said current constellation information to maintain synchronization with said actual GNSS system time.

30. The GNSS emitter system of claim 17, wherein the real time clock in said individual GNSS emitters is updated with accurate GNSS system time taken from said current constellation information to maintain synchronization with said actual GNSS system time.

31. A computer-readable medium storing computer readable instructions that, when executed by a processor, cause a GNSS emitter to provide a reconstructed signal to a GNSS receiver where said GNSS receiver receives less than a desired number of GNSS signals from GNSS satellites having a minimum signal quality, comprising the steps of:
receiving a signal from a GNSS satellite through a GNSS receiver antenna, wherein the signal comprises constellation information;
determining a list of satellites from the constellation information;
creating a satellite chipping code corresponding to the list of satellites;
modifying signal characteristics in accordance with a location of an obstructed GNSS receiver; and
outputting the signal having said modified signal characteristics to said GNSS receiver via an emitter antenna.

32. A computer-readable medium storing computer instructions that cause a GNSS emitter to provide a signal to a GNSS receiver, where said GNSS receiver receives less than a desired number of GNSS signals from GNSS satellites having a minimum signal quality, said instructions comprising the steps of:
receiving data at an emitter, wherein the data includes a location and almanac information;
determining a list of satellites from the location, almanac information and a system time;
creating signal characteristics including a pseudo random code with phase information and Doppler frequency information and navigation information corresponding to the list of satellites; and
outputting a signal having said signal characteristics to said GNSS receiver via an emitter antenna.
